(19) United States
(12) Patent Application Publication
(10) Pub. No.: US 2006/0089954 A1
(43) Pub. Date: Apr. 27, 2006

(54) Scalable common access back-up architecture

(76) Inventor: Thomas A. Anschutz, Conyers, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/301,175

(22) Filed: Dec. 12, 2005

Related U.S. Application Data
(63) Continuation-in-part of application No. 10/144,565, filed on May 13, 2002.

(51) Int. Cl. G06F 17/30

(52) U.S. Cl. 707/202

(57) ABSTRACT

Methods, systems and computer program products for providing shared file back-ups in a repository. Methods include receiving metadata of a file to be backed-up from a client. A global directory of back-up files is accessed. The global directory includes back-up file metadata and back-up file pointers corresponding to each of the back-up files in the repository. It is determined if the metadata matches one of the back-up file metadatas. If the metadata matches one of the back-up file metadatas, then the back-up file pointer corresponding to the matching back-up file metadata is added to a client directory of client back-up files in the repository.

### CROSS REFERENCE TO RELATED APPLICATIONS

This application is a continuation-in-part of U.S. patent application Ser. No. 10/144,565 filed on May 13, 2002 which is herein incorporated by reference in its entirety.

### BACKGROUND OF THE INVENTION

Exemplary embodiments relate generally to a scaleable common access back-up architecture, and more particularly, to methods, systems and computer program products for providing shared file back-ups in a repository.

System administrators and others engaged in the field of archival systems are continuously striving to find improved methods and systems to reduce the storage demand on back-up systems. Accordingly, there is a need for a back-up method and system in a networked environment that reduces the storage requirement of back-up subsystems and minimizes the burden on a low-bandwidth network. In addition, the method and system need to be scalable to any arbitrary size to provide more storage space and higher performance as the number of users increases.

### SUMMARY OF THE INVENTION

Exemplary embodiments relate to methods, systems, and computer program products for providing shared file back-ups in a repository. The methods include receiving metadata of a file to be backed-up from a client. A global directory of back-up files is accessed. The global directory includes back-up file metadata and back-up file pointers corresponding to each of the back-up files in the repository. It is determined if the metadata matches one of the back-up file metadatas. If the metadata matches one of the back-up file metadatas, then the back-up file pointer corresponding to the matching back-up file metadata is added to a client directory of client back-up files in the repository.

Systems for providing shared file back-ups in a repository include a global directory of back-up files in the repository and a server back-up module in communication with the global directory. The server back-up module includes instructions for facilitating receiving metadata of a file to be backed-up from a client. A global directory of back-up files is accessed. It is determined if the metadata matches one of the back-up file metadatas. If the metadata matches one of the back-up file metadatas, then the back-up file pointer corresponding to the matching back-up file metadata is added to a client directory of client back-up files in the repository.

Computer program products for providing shared file back-ups in a repository include a storage medium readable by a processing circuit and storing instructions for execution by the processing circuit for facilitating a method. The method includes receiving metadata of a file to be backed-up from a client. A global directory of back-up files is accessed. The global directory includes back-up file metadata and back-up file pointers corresponding to each of the back-up files in the repository. It is determined if the metadata matches one of the back-up file metadatas. If the metadata matches one of the back-up file metadatas, then the back-up file pointer corresponding to the matching back-up file metadata is added to a client directory of client back-up files in the repository.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### DESCRIPTION OF THE FIGURES

Referring now to the drawings wherein like elements are numbered alike in the several FIGURES:

FIG. 1 is a functional block diagram of a back-up system according to one embodiment of the present invention;

FIG. 2 is a functional block diagram of a back-up system according to one embodiment of the present invention;

FIG. 3 is a flow diagram of a method for storing, on a centralized mass storage device, archival data from multiple computers in a networked environment according to one embodiment of the present invention;

FIG. 4 is a flow diagram of an alternate method for storing, in a repository, archival data from multiple computers in a networked environment;

FIG. 5 is a process flow that may be implemented by exemplary embodiments to provide shared file back-ups in a repository using metadata about a file;

FIG. 6 is a process flow that may be implemented by exemplary embodiments to provide shared file back-ups in a repository using a file fingerprint; and

FIG. 7 is a process flow that may be implemented by exemplary embodiments to provide shared file back-ups in a repository.

### DETAILED DESCRIPTION OF THE INVENTION

It is to be understood that the figures and descriptions of the present invention have been simplified to illustrate elements that are relevant for a clear understanding of the present invention while eliminating, for purposes of clarity, other elements. For example, certain details relating to the operation of a communications network, such as the Internet, the specifications of data communications protocols for use in transporting data packets and certain details of suitable storage media are not described herein. Those of ordinary skill in the art will recognize, however, that these and other elements may be desirable in a typical networked environment. A discussion of such elements is not provided because such elements are well known in the art and because they do not facilitate a better understanding of the present invention.

The present invention relates to a scalable archival/retrieval system that leverages duplicate data stored across multiple networked devices. A “data file” (or “file”) broadly and without limitation refers to information storable or representable as information that can be digitally stored, or otherwise digitally represented in some type of digital format. A “digital fingerprint” represents a characteristic of a file that can be used to authenticate an original file or a copy thereof. A file “attribute” refers to any number of file characteristics including, for example, file size, date, author, or source. “Pointer,” broadly and without limitation to a database context, refers to an identifier of an actual storage location of a data file. For example, a digital fingerprint may be an index or key that is searched to find a corresponding file descriptor, uniform resource locator (URL), or universal naming convention (UNC) that may provide an actual storage location. “Scalable” refers to a networked file system that can be adjusted to any desired size without changing the underlying architecture of the system. Further, as used herein, “storage device” refers to any processing system that stores information that a user at an inquiring processor may wish to retrieve. Finally, the terms “archive”, “back-up”, “synchronized file system” and “synchronized file set” will be used interchangeable and should be understood in their broadest sense. Exemplary embodiments include a unitary collection of files, independent of an individual archive or back-up, and there may be many archives and back-up sets that exist simply as directories with pointers into the unitary collection of files.

For a general understanding of the features of the present invention, reference is made to the drawings, wherein like reference numerals have been used throughout to identify identical or functionally similar elements.

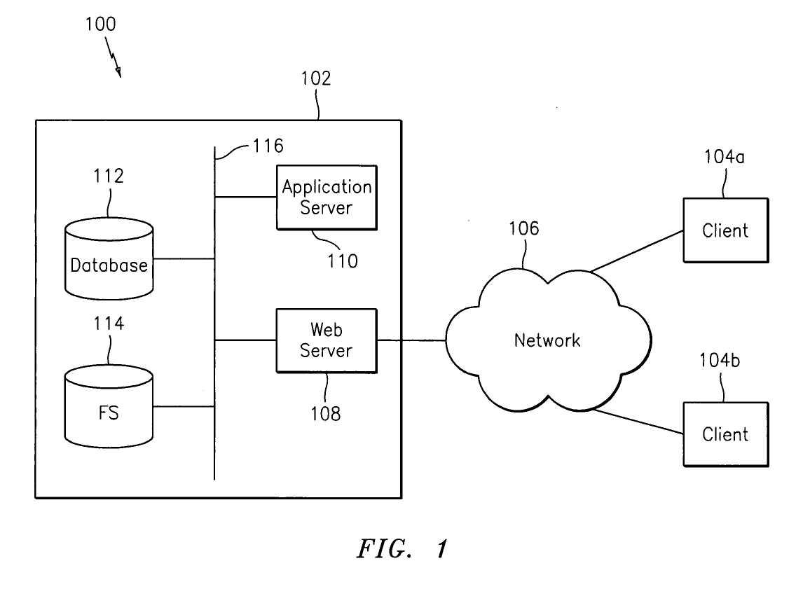

FIG. 1 is a functional block diagram depicting a system 100 according to one embodiment of the present invention. System 100 illustrates an exemplary client-server architecture that may include, for example, an electronic business center 102 in communication with remote clients 104a and 104b (collectively 104) over a network 106. Although FIG. 1 illustrates only two clients, those of ordinary skill in the art will understand that system 100 may include more. Electronic business center 102 may include one or more servers providing application program services or database services such as, for example, a web server 108, an application server 110, a database 112, and a file store 114 that communicate over local area network (LAN) 116. Those of ordinary skill in the art will understand that the electronic business center 102 may include any number of servers that provide application program services or database services. Those of ordinary skill will also understand that the present invention is not limited to a particular computer system platform, processor, operating system, or network.

Web server 108 may be, for example, an IBM PC Server, Sun Sparc Server, or an HP RISC machine having a web server application operating thereon. Database 112 and file store 114 may be any body of information that is logically organized so that it can be retrieved, stored, and searched in a coherent manner by a “database engine”—i.e. a collection of methods for retrieving or manipulating data in the database. Those of ordinary skill in the art will understand that many of the elements that comprise electronic business center 102 maybe combined. For example, application server 110 may be combined with web server 108 to create a so-called web application server. Similarly, database 112 may be combined with file store 114 without departing from the principles of the invention.

Clients 104 may communicate with web server 108 over, for example, connections of varying bandwidth and latency. Clients 104 may be any network-enabled device such as, for example, a personal computer, a personal digital assistant (PDA), a workstation, a laptop computer, a hand-held computing device, cell phone, game device, personal video recorder or combinations thereof. Clients 104 can optionally include, for example, a processing unit, a monitor, and a user interface. These are representative components of a computer whose operation is well understood.

Network 106 may be any suitable computer network. Suitable computer networks may include, for example, metropolitan area networks (MAN) and/or various “Internet” or IP networks such as the World Wide Web, a private Internet, a secure Internet, a value-added network, a virtual private network, an extranet, or an intranet. They may be wireless or wireline. Other suitable networks may contain other combinations of servers, clients, and/or peer-to-peer nodes.

Network 106 may include communications or networking software such as the software available from Novell, Microsoft, Artisoft, and other vendors. A larger network, such as a wide area network or WAN, may combine smaller network(s) and/or devices such as routers and bridges, large or small, the networks may operate using, for example, TCP/IP, SPX, IPX, and other protocols over twisted pair, coaxial, or optical fiber cables, telephone lines, satellites, microwave relays, modulated AC power lines, physical media transfer, and/or other data carrying transmission “wires” known to those of skill in the art. For convenience, the term “wires” included infrared, radio frequency, and other wireless links or connections.

Clients 104 may also include a computer readable media or medium having executable instructions or data fields stored thereon. Such computer readable media can be any available media that can be accessed by a general purpose or special purpose computer. By way of example, and not limitation, such computer readable media can comprise RAM, ROM, electrically erasable programmable read only memory (EEPROM), CD-ROM or other optical disk storage, magnetic disk storage or other magnetic storage devices, flash disk, or any other medium that can be used to store desired executable instructions or data fields and that can be accessed by a general purpose or a special purpose computer.

The computer readable storage medium or media may tangibly embody a program, functions, and/or instructions that cause the computer system to operate in a specific and predefined manner as described herein. Those skilled in the art will appreciate, however, that the process described below may be implemented at any level, ranging from hardware to application software and in any appropriate physical location. For example, certain modules may be implemented as software code to be executed by clients 104 using any suitable computer language such as, for example, microcode, and may be stored on any of the storage media described above, or can be configured into the logic of clients 104. According to another embodiment, the instructions may be implemented as software code to be executed by clients 104 using any suitable computer language such as, for example, Java, Pascal, C++, C, Perl, database languages, APIs, various system-level SDKs, assembly, firmware, microcode, and/or other languages and tools.

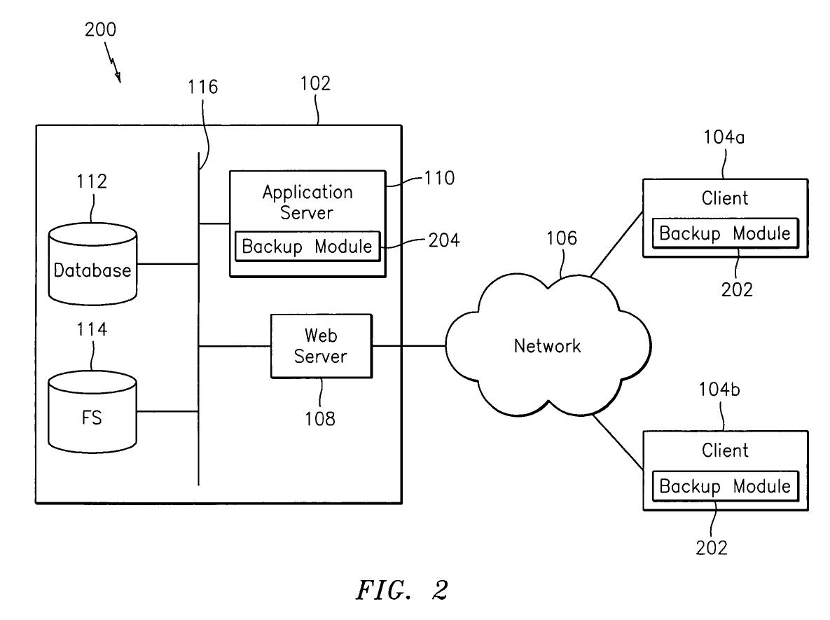

FIG. 2 is a functional block diagram depicting a system 200 according to one embodiment of the present invention. According to such an embodiment, clients 104 tangibly embody a client back-up module 202 and, similarly, application server 112 tangibly embodies a server back-up module 204. At pre-specified or periodic times client back-up module 202 is activated and communicates with server back-up module 204. These designations will become useful in the description of the embodiments as set forth below.

While each user can independently manage his/her own data on a given client, back-up and restore of data on system 200 can be centrally managed at a single location by, for example, a network administrator, from a given workstation or file server, or a system console. For example, according to another embodiment, client back-up module 202 or server back-up module 204 or both may reside on a device physically separate from their respective client devices. According to another embodiment, client back-up module 202 and server back-up module 204 may be combined and reside on any physical device in communication with system 200.

FIGS. 1 and 2, and the foregoing discussion, are intended to provide a brief, general description of a suitable computing environment in which the invention may be implemented. Although not required, the invention is described herein in the general context of computer-executable instructions, such as program modules, being executed by a computer. Thus the hardware and software configurations depicted in FIGS. 1 and 2 are intended merely to show a representative configuration. Accordingly, it should be understood that the invention encompasses other computer system hardware configurations and is not limited to the specific hardware and software configuration described above.

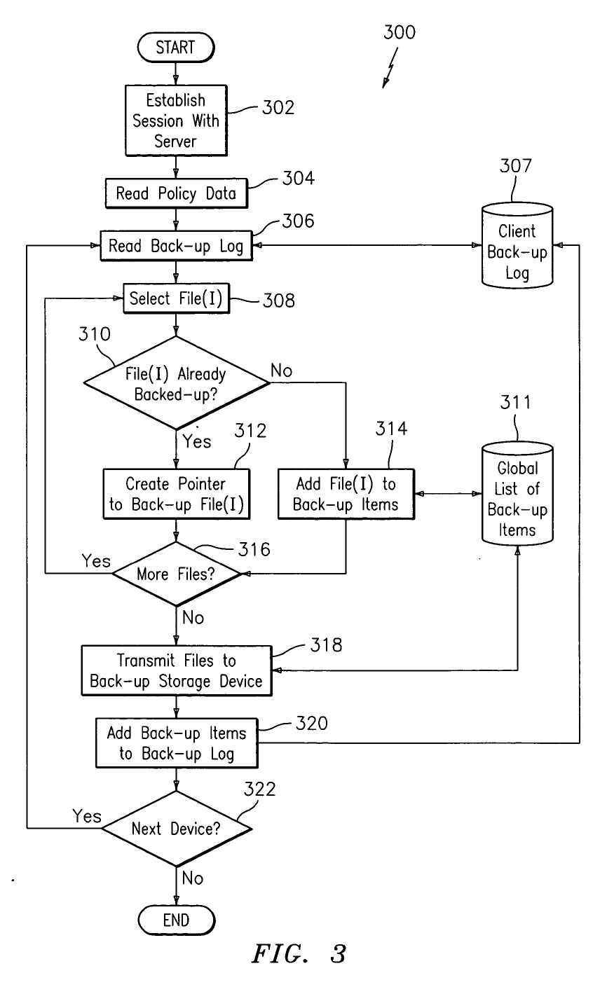

FIG. 3 is a flow diagram that illustrates an exemplary method 300 for storing, on a centralized mass storage device, archival data from multiple computers in a networked environment according to one embodiment of the present invention. In step 302, client back-up module 202 establishes a session with server back-up module 204. After establishing contact and establishing authentication, server back-up module 204 then optionally consults “policy data” in step 304 that instructs server back-up module 204 as to what sort of a back-up operation should occur and which files on, for example, client 104a are the subjects of the current back-up. In step 306, system 200 reads, for example, a client back-up log 307 that lists all previously backed-up data files from clients 104a and 104b, collectively. Client back-up module 202 then searches, in step 308, for all or a subset of files on client 104a and determines which files should be backed up based on the policy data read in step 304.

In step 310, after selecting the files to be backed up, client back-up module 202 compares each selected file, designated file(I), to client back-up log 307. If system 200 has not previously backed up a file identical to file (I) then system 200 adds file(I) to a current global back-up list 311 for back-up in the current session in step 312. If system 200 identifies a file identical to file(I) on back-up log 307, system 200 creates a pointer to the backed up file in step 314.

Step 310 may invoke a variety of file differencing algorithms familiar to those of ordinary skill in the art such as, for example, the UNIX diff and delta functions. According to one embodiment, step 310 may compare a digital fingerprint of file(I) or otherwise demonstrate that file(I) is identical to a backed up file. For example, system 200 could authenticate whether file(I) is identical to a backed up file by generating such a digital fingerprint for file(I) and comparing it to a digital fingerprint retrieved from various of the storage locations. According to others embodiments, step 310 may use, for example, a checksum count, a cyclical redundancy check, or a set of file properties or other embedded information identifiers to compare or otherwise demonstrate that file(I) is identical to a backed-up file.

In step 316, system 200 checks client 104a for additional files to be backed up in the current session. If more files remain, system 200 returns to step 308 and repeats the same sequence. Otherwise, system 200 transmits the files on current global back-up list 311, over network 106, to the back-up storage device or, in this example, file store 114. System 200 then updates client back-up log 307 in step 320. After completing the process for client 104a, system 200 proceeds to client 104b until it completes all of the networked devices designated for back-up. After processing the last file, method 300 terminates the process.

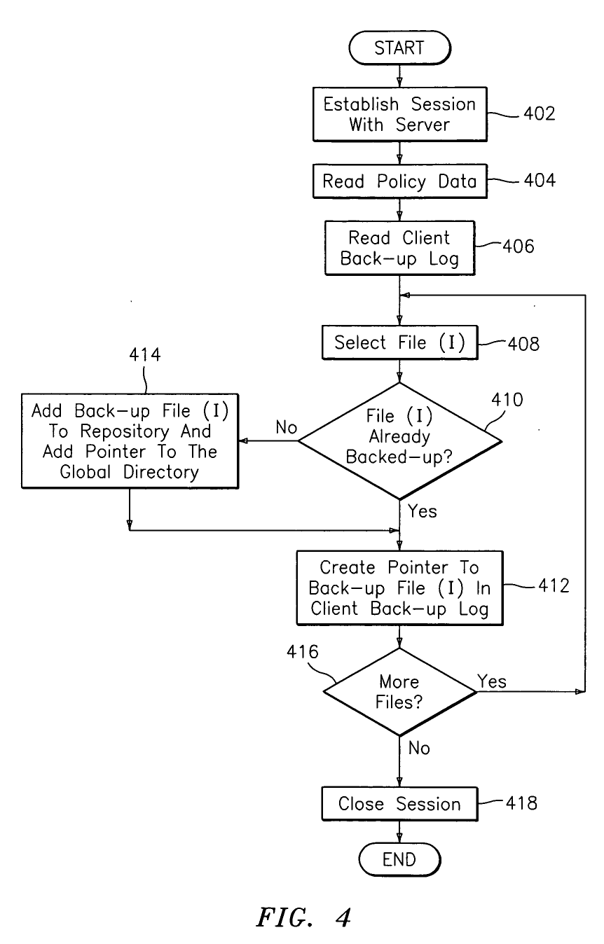

FIG. 4 is a flow diagram that illustrates an alternate exemplary process for storing, in a centralized repository, archival data from multiple computers (e.g, clients) in a networked environment. At block 402, client back-up module 202 on client 104a establishes a session with server back-up module 204. After establishing contact and establishing authentication, server back-up module 204 then optionally consults “policy data” at block 404 that instructs server back-up module 204 as to what sort of a back-up operation should occur and which files on, for example, client 104a are the subjects of the current back-up. At block 406, system 200 reads, for example, a client back-up log 307 that lists all previously backed-up data files from client 104a. Client back-up module 202 then searches, in step 408, for all or a subset of files on client 104a and determines which (new and/or recently updated) files should be backed up based on the policy data read in block 404. In exemplary embodiments, the client back-up log 307 includes a “back-up bit” that indicates if a client file has been modified since the last back-up of the file was taken.

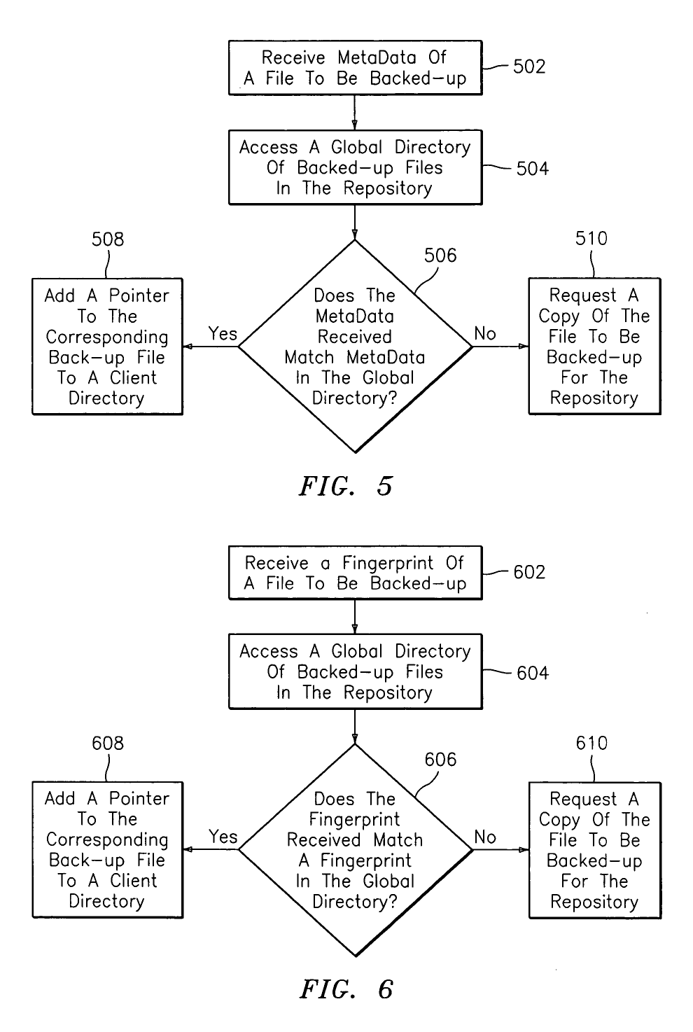

In block 410, after selecting the files to be backed up, client back-up module 202 compares each selected file, designated file(I), to the global list of back-up items 311 (e.g., back-up files that are stored in the central repository). See FIGS. 5-7 for exemplary processes for determining if each file has a back-up file in the central repository of back-up files. If system 200 has not previously backed up a file identical to file(I) then, at block 414, system 200 adds a back-up file of file(I) to the repository including adding a pointer to the back-up copy into the global list of back-up items 311.

After adding a new file to the repository (e.g., located on the file store 114 and/or the database 112) or if system 200 immediately identifies a file identical to file(I) on the global list of backup items 311, then system 200 creates a pointer to the backed up file and places it in the client back-up log 307 at block 412. As described previously, with respect to FIG. 3, block 410 may invoke a variety of file differencing algorithms familiar to those of ordinary skill in the art such as, for example, the UNIX diff and delta functions. According to one embodiment, block 410 may compare a digital fingerprint of file(I) or otherwise demonstrate that file(I) is identical to a backed up file. For example, system 200 could authenticate whether file(I) is identical to a backed up file by generating such a digital fingerprint for file(I) and comparing it to a list of globally obtained digital fingerprints created from other back-ups or during a system seeding/bootstrap process and retrieved from either a global list or from various of the storage locations. According to other embodiments, block 410 may use, for example, a checksum count, a cyclical redundancy check, or a set of file properties or other embedded information identifiers, or metadata to compare or otherwise demonstrate that file(I) is identical to a backed-up file.

In block 416, system 200 checks client 104a for additional files to be backed up in the current session. If more files remain, system 200 returns to block 408 and repeats the same sequence. After completing the process for client 104a, system 200 ends the back-up session with client 104a at block 418. Similar sessions with other clients, like 104b, may run sequentially and/or concurrently with the one described here. In exemplary embodiments, much of the processing depicted in FIG. 4 would be performed as a set of parallel processes. For example, once a file is identified to be backed-up, the file would be queued to be sent to the repository and the process would proceed to checking the metadata (e.g., fingerprints) of follow-on files.

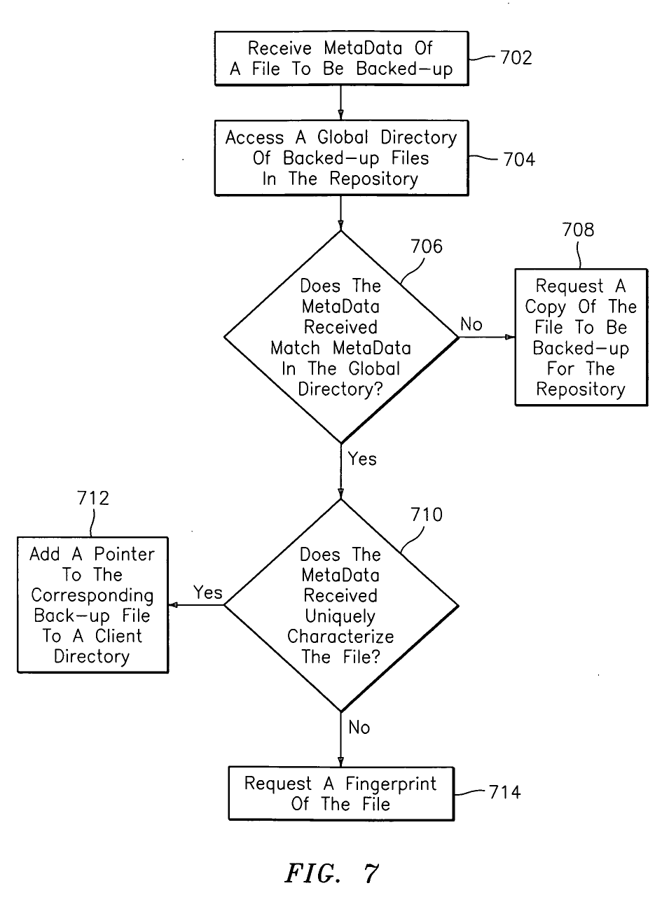

FIGS. 5-7 are flow diagrams of processes that may be implemented by exemplary embodiments to perform the processing in blocks 410, 412 and 414 of FIG. 4. The processing depicted in FIG. 5 utilizes metadata about a file to determine if the file has already been backed-up. The processing depicted in FIG. 6 utilizes a fingerprint to determine if the file has already been backed up, and the processing depicted in FIG. 7 utilizes both the metadata and the fingerprint. Referring to FIG. 5 at block 502, metadata of a file to be backed-up is received from one of the clients 104 via the network 106. The server back-up module 204 controls access to a repository of back-up files that may be physically located across one or more databases 112 and file servers 114. The contents of the metadata may vary (e.g., depending of the file type) and include any internalized and/or derived information about the file. Examples of metadata include, but are not limited to: file name, file size, creation data, revision number, version, patch level, artist, title, encoding quality, and fingerprint. The fingerprint may include one or more of a digital fingerprint, a checksum count and a cyclical redundancy check. For example, metadata about a program file may include version and patch level; and metadata about an audio file may include title, artist, and encoding quality. These are just examples, other files may contain different types of metadata. Examples of file types include, but are not limited to: programmatic files (e.g., operating systems), non-programmatic files that are not created by a user (e.g., icons, pictures and help files) and non-programmatic files that are created by the user (e.g., documents and spreadsheets).

At block 504 in FIG. 5, a global directory of backed-up files in the repository (also referred to herein as the global list of back-up items 311) is accessed. In exemplary embodiments, the global directory includes back-up file metadata for each of the backed-up files along with back-up file pointers to each of the backed-up files. In exemplary embodiments, the global directory includes one entry for each backed-up file in the repository, with each entry including the metadata and the pointer to the back-up file. In exemplary embodiments, the back-up files in the repository are accessed via the global directory, but the back-up files may be physically located in a plurality of different locations. At block 506, it is determined if the metadata received at block 502 matches any of the back-up file metadata in the global directory. If the metadata received does match the back-up file metadata for one of the files in the repository, then it is assumed that a back-up for the file already exists in the repository. In this case, block 508 is performed, and a pointer to the back-up file in the repository is added to a client directory (also referred to herein as the client back-up log 307). The client directory includes a list of files located on the client that have been backed-up to the repository. The client directory may be utilized to recreate the client, to recreate specific files on the client, and to perform synchronization between the client and another client/system. The back-up files in the repository may be shared by multiple clients and thus, multiple client directories may include pointers to the same back-up file in the repository.

If the metadata received does not match the back-up file metadata for one of the backed-up files in the repository (i.e., a back-up of the file does not exist in the repository), then block 510 in FIG. 5 is performed. At block 510, a copy of the file for the repository is requested from the client. Once the copy is received it is stored as a back-up copy of the file in the repository. Metadata about the file and a pointer to the location of the back-up copy of the file in the repository is added to the global directory. In addition, a pointer to the back-up copy of the file in the repository is added to the client directory. In exemplary embodiments, a command is transmitted to the client to indicate that the file has been backed-up to the repository.

In exemplary embodiments, additional bandwidth saving techniques are employed when a copy of the file is requested to be sent to the repository. For example, in one technique, only the changed portions of the file are transmitted to the repository. In some cases, because of the asymmetric nature of consumer Internet access, it may be faster to send a copy of the old file from the repository to the client, so that the client can perform a difference function and only send the portion needed to update the file back to repository.

FIG. 6 contains a process flow that is the same as the process flow described above in reference to FIG. 5 except for instead of receiving metadata about a file to be backed-up, a fingerprint of the file to be backed-up is received from the client. The fingerprint is compared to the metadata to determine if metadata of a backed-up matches the fingerprint of the file. If a match is found, then the file is assumed to be backed-up and a copy of the file does not need to be transmitted to the repository. As described above, a fingerprint is a specific type of metadata and may include one or more of a digital fingerprint, a checksum count, and a cyclical redundancy check.

FIG. 7 is a process flow that may be implemented by alternate exemplary embodiments. The process flow in FIG. 7 utilizes both metadata (which may or may not include a fingerprint) and a fingerprint (which may not be included in the metadata and may need to be generated by the client and/or the repository) to determine if a file has a back-up copy already available in the repository. At block 702, metadata of a file to be backed-up is received from one of the clients 104 via the network 106. At block 704 in FIG. 7, the global directory of backed-up files in the repository is accessed. At block 706, it is determined if the metadata received at block 702 matches any of the back-up file metadata in the global directory. If the metadata received does not match the back-up file metadata for one of the backed-up files in the repository (i.e., a back-up of the file does not exist in the repository), then block 708 in FIG. 7 is performed. At block 708, a copy of the file for the repository is requested from the client. Once the copy is received, it is stored as a back-up copy of the file in the repository. Metadata about the file and a pointer to the location of the back-up copy of the file in the repository are added to the global directory. In addition, a pointer to the back-up copy of the file in the repository is added to the client directory. In exemplary embodiments, a command is transmitted to the client to indicate that the file has been backed-up to the repository.

If the metadata received does match the back-up file metadata for one of the files in the repository, as determined at block 706, then block 710 is performed. At block 710, a check is made to determine if the metadata received uniquely characterizes the file. For example, program files may be uniquely characterized by metadata that includes version and patch level, while an audio file may be uniquely characterized by metadata that includes title, artist and encoding quality. If it is determined at block 710, that the metadata uniquely characterizes the file, then block 712 is performed and it is assumed that a back-up for the file already exists in the repository. In this case, a pointer to the back-up file in the repository is added to the client directory.

If it is determined, at block 710, that the metadata received does not uniquely characterize the file, then block 708 is performed. At block 708, a request is made to the client for a fingerprint of the file. Processing would then continue with block 602 of FIG. 6. Alternatively, processing continues by verifying that the fingerprint matches the fingerprint associated with the back-up file with the metadata as determined at block 706. In exemplary embodiments, a non-programmatic file may require a fingerprint in addition to metadata such as file name and file size to uniquely characterized the file. In this case, block 714 would be performed to verify that the backed-up file is the same as the received file if the file name and file size (the metadata) of the received file were located in the global directory.

Exemplary embodiments may be utilized to support the sharing of large files among a group of users without requiring the files to be transmitted from client machine to client machine. For example, a user may have a number of large data files (e.g., photographs and video clips) that he wants to share with family/friends. The user and/or his family/friends may not have the capacity to transmit the large data files. The user sets up a client directory of the large data files to be shared with family/friends. The client directory is e-mailed to the family/friends (another user). The family/friends receive the directory and request that the back-up files in the client directory be restored to their client or that they view the back-up file in the repository. In this manner, the user can share large files with family/friends without being required to have the capacity to transmit the data files.

Exemplary embodiments may be utilized to support back-up, archive and synchronization of files in any environment. For example, exemplary embodiments may be utilized to provide back-up and synchronization in an Internet protocol television (IPTV) environment. The set-top boxes containing the movies (or movie segments) could operate as the clients and metadata could include information about the movie (e.g., movie name, encoding quality, etc.)

Exemplary embodiments may be utilized to provide shared file back-ups in a repository. Utilizing exemplary embodiments will result in saving storage space because a single physical back-up file may be utilized by multiple clients. In addition, transmission costs will be lower because checks for similar attributes and further verification are performed before transmitting a back-up copy of the data file to the repository.

It should be understood that the present invention is not limited by the foregoing description, but embraces all such alterations, modifications, and variations in accordance with the spirit and scope of the appended claims.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for providing shared file back-ups in a repository, the method comprising:
receiving metadata of a file to be backed-up from a client;
accessing a global directory of back-up files including back-up file metadata and back-up file pointers corresponding to each of the back-up files in the repository;
determining if the metadata matches one of the back-up file metadatas; and
if the metadata matches one of the back-up file metadatas, then adding the back-up file pointer corresponding to the matching back-up file metadata to a client directory of client back-up files in the repository.

2. The method of claim 1 further comprising requesting a copy of the file for the repository from the client if the metadata does not match one of the back-up file metadatas.

3. The method of claim 2 further comprising:
receiving the copy of the file for the repository from the client;
adding the metadata of the file and a pointer to the copy of the file into the global directory; and
adding the pointer to the copy of the file to the client directory.

4. The method of claim 3, further comprising transmitting a command to the client indicating that the file has been backed-up on the repository.

5. The method of claim 1 wherein the file is a program file and the metadata includes version and patch level.

6. The method of claim 1 wherein the file is an audio file and the metadata includes title, artist and encoding quality.

7. The method of claim 1 wherein the metadata includes one or more of derived and internalized information about the file.

8. The method of claim 1 further comprising transmitting the client directory to an other client, wherein the other client utilizes the client directory to access the client back-up files in the repository.

9. The method of claim 1 wherein the metadata includes a fingerprint.

10. The method of claim 9 wherein the fingerprint includes a digital fingerprint.

11. The method of claim 9 wherein the fingerprint includes one or more of a checksum count and a cyclical redundancy check.

12. A system for providing shared file back-ups in a repository, the system comprising:
a global directory of back-up files including back-up file metadata and back-up file pointers corresponding to each of the back-up files in the repository; and
a server back-up module in communication with the global directory and including computer instructions for facilitating:
receiving metadata of a file to be backed-up from a client;
accessing the global directory of back-up files;
determining if the metadata matches one of the back-up file metadatas; and
if the metadata matches one of the back-up file metadatas, then adding the back-up file pointer corresponding to the matching back-up file metadata to a client directory of client back-up files in the repository.

13. The system of claim 12 wherein the computer instructions further facilitate requesting a copy of the file for the repository from the client if the metadata does not match one of the back-up file metadatas.

14. The system of claim 12 wherein the back-up files in the repository are accessed via the global directory and physically located in a plurality of locations.

15. The system of claim 12 wherein the back-up files in the repository are received from a plurality of clients.

16. The system of claim 12 wherein at least one of the back-up file pointers is located in a plurality of client directories.

17. The system of claim 12 wherein the client directory is utilized to restore the client.

18. A computer program product for use in a computing system for providing shared file back-ups in a repository, the computer program product comprising:
a storage medium readable by a processing circuit and storing instructions for execution by the processing circuit for facilitating a method comprising:
receiving metadata of a file to be backed-up from a client;
accessing a global directory of back-up files including back-up file metadata and back-up file pointers corresponding to each of the back-up files in the repository;
determining if the metadata matches one of the back-up file metadatas; and
if the metadata matches one of the back-up file metadatas, then adding the back-up file pointer corresponding to the matching back-up file metadata to a client directory of client back-up files in the repository.

19. The computer program product of claim 18 wherein the instructions further facilitate requesting a copy of the file for the repository from the client if the metadata does not match one of the back-up file metadatas.

20. The computer program product of claim 18 wherein the instructions further facilitate:
receiving the copy of the file for the repository from the client;
adding the metadata of the file and a pointer to the copy of the file into the global directory; and
adding the pointer to the copy of the file to the client directory.
